(19) United States
(12) Patent Application Publication
(10) Pub. No.: US 2025/0151734 A1
(43) Pub. Date: May 15, 2025

(54) ACID AND ALKALI-RESISTANT AND THERMOSTABILIZED ANTIMICROBIAL PEPTIDES, AND MANUFACTURE METHODS AND APPLICATIONS THEREOF

(71) Applicant: Nano and Advanced Materials Institute Limited, Hong Kong (HK)

(72) Inventors: Wah Kit CHEUK, Hong Kong (HK); Shi Min TAN, Hong Kong (HK); Chun Hay KO, Hong Kong (HK); Wing Man CHAN, Hong Kong (HK)

(21) Appl. No.: 18/506,144

(22) Filed: Nov. 10, 2023

(51) Int. Cl. A01N 63/50; A01N 25/28; A01P 1/00; A23L 3/3544

(52) U.S. Cl. CPC A01N 63/50; A01N 25/28; A01P 1/00; A23B 2/771

(57) ABSTRACT

An acid and alkali-resistant, as well as thermostabilized antimicrobial peptide is provided. This peptide is engineered to endure extreme pH conditions, high temperatures, and sustain its natural conformation. This is achieved by bonding the antimicrobial peptide with a structure-lock component via non-covalent interactions, effectively preserving its biologically active conformation. Moreover, the antimicrobial peptide is enveloped within a controlled release encapsulation material, facilitating controlled and sustained release in diverse applications.

### FIELD OF THE INVENTION

The present invention generally relates to the field of food science. More specifically the present invention relates to acid and alkali-resistant and thermostabilized antimicrobial peptides.

### BACKGROUND OF THE INVENTION

Chemical preservatives are commonly used in a variety of products to extend shelf life, yet their long-term adverse effects are often underestimated. Excessive use of these preservatives has also contributed to the emergence of resistant microbes, a major concern for industries such as food and beverages, cosmetics, personal care, and pharmaceuticals. This has spurred greater awareness and a demand for the development of healthier and safer preservatives suitable for commercial products.

Antimicrobial peptides (AMPs) are naturally derived peptide compounds seen as promising alternatives to chemical preservatives. AMPs exhibit strong antimicrobial properties, are effective against a broad spectrum of microbes, and have low toxicity. However, these peptide-based compounds are sensitive to changes in pH and temperature, and they can be susceptible to enzymatic degradation and hydrophobic aggregation in different environments. These instability issues have limited the application of AMPs in various commercial products.

Numerous patent applications in this field have introduced various technologies for safeguarding antimicrobial peptides (AMPs). For instance:
(1) US20200231638A1 presents several methods for enhancing the stability of AMPs. One approach involves hydrocarbon stapling, where a synthetic hydrocarbon cross-link is introduced between two amino acids in the peptide, stabilizing its structure. Another method employs lactam bridges, formed by creating a covalent bond between two amino acid side chains to bolster the peptide's structure. The patent also explores other stabilizing agents like disulfide bridges and non-natural amino acids. These techniques yield stabilized AMPs with improved effectiveness against bacterial infections.
(2) U.S. Pat. No. 9,617,309B2 introduces proline-locked stapled peptides and their applications. This invention details a method for peptide stabilization through the introduction of a stapling agent that covalently binds two amino acids, thereby restricting flexibility and enhancing stability. These stapled peptides hold potential for therapeutic use in treating conditions like cancer and viral infections. The patent also outlines methods for stapled peptide synthesis and screening, along with pharmaceutical compositions incorporating them.
(3) WO2011116963A2 offers a method for preparing lipid nanoparticles suitable as carriers for active agents, such as drugs or cosmetic ingredients. This technique involves emulsifying a mixture of lipids, polymers, and cationic agents in an aqueous solution, solidifying the emulsion to form solid lipid nanoparticles, and coating these nanoparticles with a second layer of polymers to enhance stability and regulate active agent release. The patent includes specific examples of lipid nanoparticles and highlights their potential applications in drug delivery and cosmetic formulations.
(4) US20230035898A1 introduces cyclodextrin protein drug conjugates. This patent application focuses on employing cyclodextrins, cyclic oligosaccharides, to conjugate drugs with proteins. This conjugation can enhance drug pharmacokinetics, including solubility, stability, and half-life in the body. The patent emphasizes the conjugation of cyclodextrins with antibodies, which can be applied in treating various diseases.

Nevertheless, these references rarely delve into dual protection methods for AMPs and peptide-based substances, encompassing both structural confinement and encapsulation to shield against environmental challenges and enzymatic digestion. Consequently, there exists a crucial necessity for developing AMPs with enhanced stability across diverse environments to synergistically safeguard and sustain their antimicrobial effectiveness. The present invention aims to address these needs.

### SUMMARY OF THE INVENTION

It is an objective of the present invention to provide compound, method, or application to solve the aforementioned technical problems.

In accordance with a first aspect of the present invention, an acid and alkali-resistant and thermostabilized AMP is provided. Particularly, the acid and alkali-resistant and thermostabilized AMP is an AMP bond with a structure-lock component through a non-covalent bond to maintain the AMP in its native conformation and encapsulated by a controlled release encapsulation material.

In accordance with one embodiment of the present invention, the non-covalent bond is selected from a hydrogen bond, a Van der Waals bond, a hydrophobic interaction or an electrostatic interaction.

In accordance with another embodiment of the present invention, the structure-lock component binds to hydrophobic residues of the AMP.

In accordance with one embodiment of the present invention, the AMP is selected from nisin, polylysine, cecropin, defensin, bacitracin, lacticin, a salt thereof or any combinations thereof.

In accordance with one embodiment of the present invention, the structure-lock component is selected from cyclodextrins, polylysine, zein, silk fibroin, silk sericin, a salt thereof or any combinations thereof.

In accordance with one embodiment of the present invention, he encapsulation material is a polymer or a lipid component, including a polyvinylpyrrolidone, a solid lipid, a natural wax and a salt thereof.

In accordance with one embodiment of the present invention, the acid and alkali-resistant and thermostabilized AMP has an antimicrobial effect against Escherichia coli, Staphylococcus aureus and Candida albicans for at least 99%.

In accordance with one embodiment of the present invention, the acid and alkali-resistant and thermostabilized AMP is stable and functioned at a pH value range of 4-10.

In accordance with one embodiment of the present invention, the acid and alkali-resistant and thermostabilized AMP is stable and functioned at a temperature range of 0-120° C.

In accordance with a second aspect of the present invention, a method for manufacturing an acid and alkali-resistant and thermostabilized antimicrobial peptide is introduced. The method includes capping and/or grafting a structure-lock component on the hydrophobic residues of an AMP to obtain a structural-locked peptide and homogenizing the structural-locked peptide with an encapsulation material and a membrane penetration enhancer in a solvent to form an acid and alkali-resistant and thermostabilized AMP.

In accordance with one embodiment of the present invention, the weight percentages of the AMP, the structure-lock component, the encapsulation material, the membrane penetration enhancer and the solvent are 0.5-38 wt. %. 0.5-38 wt. %, 0.01-5 wt. %, 0.01-47 wt. % and 0-98.98%, respectively.

In accordance with another embodiment of the present invention, the AMP is 0.5-1 wt. %, the structure-lock component is 0.5-1 wt. %, the encapsulation material is 0.01-0.1 wt. %. the membrane penetration enhancer is 0.01-0.55 wt. % and the solvent is 97.35-98.98 wt. %.

In accordance with one embodiment of the present invention, the AMP is 25-38 wt. %, the structure-lock component is 25-38 wt. %, the encapsulation material is 3-5 wt. % and the membrane penetration enhancer is 19-47 wt. %.

In accordance with one embodiment of the present invention, the size of the structural-locked peptide is in a range of 100-1000 nm.

In accordance with one embodiment of the present invention, the AMP is selected from nisin, polylysine, cecropin, defensin, bacitracin, lacticin, a salt thereof or any combinations thereof.

In accordance with one embodiment of the present invention, the structure-lock component is selected from cyclodextrins, polylysine, zein, silk fibroin, silk sericin, a salt thereof or any combinations thereof.

In accordance with one embodiment of the present invention, the encapsulation material is a polymer or a lipid component, including a polyvinylpyrrolidone, a solid lipid, a natural wax and a salt thereof.

In accordance with one embodiment of the present invention, the membrane penetration enhancer is selected from citric acid, phytic acid, myristic acid, fumaric acid, mandelic acid, succinic acid, lauric acid, honokiol, poly-L-lysine or a salt thereof.

In accordance with one embodiment of the present invention, the solvent is selected from water, isopropyl alcohol or ethyl alcohol.

In accordance with a third aspect of the present invention, an acid and alkali-resistant, thermostabilized and non-toxic preservative is provided. The preservative includes the acid and alkali-resistant and thermostabilized AMP.

In accordance with a fourth aspect of the present invention, an acid and alkali-resistant, thermostabilized and non-toxic food addictive is provided. The acid and alkali-resistant, thermostabilized and non-toxic food addictive includes the acid and alkali-resistant and thermostabilized AMP.

### BRIEF DESCRIPTION OF THE DRAWINGS

Embodiments of the invention are described in more details hereinafter with reference to the drawings, in which:

FIG. 1 depicts a schematic diagram showing capping and/or grafting a structure-lock component on the hydrophobic residues of an AMP;

FIG. 2 depicts the encapsulation of structural-locked AMP and the application thereof;

FIG. 3 demonstrates the appearances of nisin dissolved in β-cyclodextrin (CD) in different ratios;

FIGS. 4A-4B depict the experimental design and the results of thin layer chromatography (TLC), in which FIG. 4A shows the TLC design and FIG. 4B demonstrates the UVC visualization of completed TLC plate, stained with iodine and vanillin, respectively;

FIG. 5 displays the results of Zone of inhibition experiments determining the antibacterial effect before and after protease digestion;

FIG. 6 exhibits the appearances of encapsulated AMP solutions;

FIGS. 7A-7B display the scanning electron microscope (SEM) images of nisin/cyclodextrin/poly-L-lysine/propolis mixed freeze-dried powder, in which FIG. 7A is a 5000× magnification SEM image and FIG. 7B is a 10000× magnification SEM image;

FIG. 8 depicts the particle distribution of AMP_NACDPLLHKP_05-05-1;

FIG. 9 displays a SEM image of AMP_NACDPLLHKP_05-05-1;

FIG. 10 shows clear zones of inhibition for various formulation treated with S. aureus and E. coli at different pH values; and

FIG. 11 depicts the antibacterial assessments of nisin: cyclodextrin formulations incorporated with honokiol and poly-L-lysine.

### DETAILED DESCRIPTION

In the following description, compounds, manufacture methods, and/or applications of acid and alkali-resistant and thermostabilized AMPs and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

As used herein, the term “controlled release” refers to a deliberate and regulated manner of delivering a substance, such as an active ingredient or component, over an extended period and in a specific manner. Controlled release mechanisms are designed to release the substance at a predetermined rate and duration, ensuring that it maintains therapeutic or functional levels within a target environment. This controlled and sustained release is typically achieved through encapsulation, coating, or other delivery technologies to optimize the substance's effectiveness while minimizing potential side effects or wastage. Controlled release systems are valuable in various fields, including pharmaceuticals and food science, where maintaining consistent levels of active components is crucial for desired outcomes.

As used herein, the term “structure-lock” refers to a mechanism or component that is employed to stabilize or maintain the specific structural arrangement or conformation of a molecule, such as an AMP. This locking mechanism, which can be formed through non-covalent bonds like hydrogen bonds, Van der Waals interactions, hydrophobic interactions, or electrostatic interactions, helps preserve the molecular structure and functionality of the AMP. The structure-lock component is strategically applied to the hydrophobic residues of the AMP, ensuring that it retains its intended conformation, even under adverse conditions.

As used herein, the term “native conformation” pertains to the natural and biologically active three-dimensional structure of a molecule, such as a protein or peptide, in its unaltered state. It represents the specific arrangement of atoms and functional groups that enables the molecule to perform its intended biological function effectively. In the present invention, maintaining the AMP in its “native conformation” is crucial for ensuring its antimicrobial activity. The structure-lock component helps preserve this native conformation, allowing the AMP to function optimally, particularly under challenging conditions like exposure to acids, alkalis, and high temperatures.

As used herein, the term “encapsulation” refers to encapsulating protective materials to the outer shell of AMPs, forming a nanoparticle. Through this, AMP will be gradually released and remain active during the contact with microbes.

In accordance with a first aspect of the present invention, an acid and alkali-resistant and thermostabilized AMP is provided.

The acid and alkali-resistant and thermostabilized AMP is defined by its robustness in the face of different pH value and temperature conditions. Its exceptional resilience is achieved through a strategic combination of components. The AMP itself is bonded with a structure-lock component via a non-covalent bond. This unique bond serves as the linchpin in preserving the native conformation of the antimicrobial peptide. Moreover, the entire structure is encapsulated within a controlled-release encapsulation material, enhancing its stability and controlled release properties.

The non-covalent bond that secures the antimicrobial peptide's native conformation can take various forms, including hydrogen bonds, Van der Waals bonds, hydrophobic interactions, or electrostatic interactions. This bond plays a pivotal role in maintaining the peptide's antimicrobial efficacy.

Crucially, the structure-lock component, which forms this non-covalent bond with the antimicrobial peptide, primarily interacts with the peptide's hydrophobic residues. This interaction acts as a structural lock, preventing any loss of antimicrobial activity even under challenging conditions.

The versatility extends to the choice of antimicrobial peptides. Various peptides, including but not limited to nisin, polylysine, cecropin, defensin, bacitracin, and lacticin, or their salts, can be employed. This diversity enables tailoring the antimicrobial peptide to address specific needs or target a broad spectrum of pathogens effectively.

The structure-lock component, a critical element in preserving the antimicrobial peptide's native conformation, can be selected from a range of materials. Options include cyclodextrins, polylysine, zein, silk fibroin, silk sericin, or their salts. This selection allows for customization to meet the specific requirements of diverse applications.

To further augment stability and enable controlled release, the AMP is encapsulated within an encapsulation material. This material can be either a polymer or a lipid component and may encompass substances like polyvinylpyrrolidone, solid lipids, natural waxes, or their salts. It provides a shield effect for peptides and prolong its sustainability period prior to reaction with microbes. This technique also compensates the disadvantages of structural-lock protection, in which AMPs are still susceptible to enzymatic degradation and/or hydrophobic aggregation. Through the utilization and synergistic effect of structural-lock protection and encapsulation, the antimicrobial activity of AMPs under varying conditions are retained and stability of AMPs are improved, and commercially exploit across diverse range of commercial products. This encapsulation strategy extends the duration of the peptide's antimicrobial action, ensuring long-lasting effectiveness.

One of the most remarkable features of this acid and alkali-resistant and thermostabilized AMP is its exceptional antimicrobial efficacy. It demonstrates remarkable effectiveness against a spectrum of pathogens, notably Escherichia coli, Staphylococcus aureus, and Candida albicans, achieving a minimum antimicrobial effect of 99%.

The versatility of this AMP is further underscored by its adaptability to varying conditions. It remains stable and fully functional across a broad pH range of 4-10, accommodating diverse environmental conditions. Additionally, it withstands temperatures ranging from 0 to 120° C. without losing efficacy.

In conclusion, the acid and alkali-resistant and thermostabilized AMP represents a monumental advancement in antimicrobial technology. Its structural enhancements, stability, and broad-spectrum efficacy show the potential of multiple applications, from healthcare to food preservation and beyond.

In accordance with a second aspect of the present invention, a method for manufacturing an acid and alkali-resistant and thermostabilized AMP is provided. This method, elucidated herein in a narrative fashion, unveils the intricate process behind crafting this remarkable antimicrobial agent.

The process commences with the capping and/or grafting of a structure-lock component onto the hydrophobic residues of an AMP. This transformative step yields a structural-locked peptide, a key element in ensuring the peptide's integrity and efficacy. By binding with the hydrophobic residues, the structure-lock component acts as a guardian, preserving the antimicrobial peptide's native conformation even under adverse conditions.

In one embodiment, the fabrication involves two simple steps for industrial mass-production. The first step utilizes capping and/or grafting structural-lock components, such as cyclodextrins on the hydrophobic residues of peptides through physical mixing method under controlled temperature and time. The second step involves the encapsulation of lipids and/or polysaccharides materials such as cetylpalmitate (solid lipid) on structural-locked peptide through homogenization processes, including pressured homogenization method under controlled temperature and time. The resulting AMPs can be isolated by centrifuge or filtration processes.

The structural-locked peptide, having undergone this critical bonding process, is then homogenized with two additional components: an encapsulation material and a membrane penetration enhancer. These ingredients are harmoniously blended within a solvent, forging the foundation of the acid and alkali-resistant and thermostabilized AMP. This synthesis is meticulously conducted to attain the desired properties of stability, controlled release, and enhanced antimicrobial activity.

To provide a framework for the composition, weight percentages are carefully considered. The method accommodates a range of weight percentages, ensuring flexibility in tailoring the antimicrobial peptide for specific applications. The weight percentages encompass the AMP, the structural-locked peptide, the encapsulation material, the membrane penetration enhancer, and the solvent. This comprehensive range spans from 0.01% to 38% for each component except the solvent, offering the adaptability required for diverse applications.

As an illustrative example, one formulation might include 0.5-1% AMP, 0.5-1% structure-lock component, 0.01-0.1% encapsulation material, 0.01-0.55% membrane penetration enhancer, and 97.35-98.98% solvent. Conversely, another formulation may consist of 25-38% AMP, 25-38% structure-lock component, 3-5% encapsulation material, and 19-47% membrane penetration enhancer. This wide range of compositions empowers customization to meet specific needs and optimize performance.

Size is a crucial factor in the effectiveness of the structural-locked peptide. The method ensures that the size of the structural-locked peptide falls within a range of 100-1000 nanometers, a dimension conducive to controlled release and enhanced antimicrobial activity.

The AMP selected for this method is versatile, encompassing options such as nisin, polylysine, cecropin, defensin, bacitracin, lacticin, or their salts. This variety allows for the tailoring of the peptide's antimicrobial properties to address specific pathogens or applications.

The structure-lock component, essential for maintaining the peptide's native conformation, can be chosen from a diverse array of materials. Options include cyclodextrins, polylysine, zein, silk fibroin, silk sericin, or their salts. This selection affords adaptability to different environmental conditions and applications.

An encapsulation material, integral to achieving controlled release, can be either a polymer or a lipid component. Options encompass polyvinylpyrrolidone, solid lipids, natural waxes, or their salts. This encapsulation strategy ensures the prolonged release of the AMP, enhancing its efficacy.

To bolster membrane penetration and further optimize antimicrobial activity, a membrane penetration enhancer is included. This enhancer can be selected from citric acid, phytic acid, myristic acid, fumaric acid, mandelic acid, succinic acid, lauric acid, honokiol, poly-L-lysine, or their salts. It plays a pivotal role in enhancing the peptide's ability to combat pathogens effectively.

The solvent for this intricate synthesis unfolds is selected from options such as water, isopropyl alcohol, or ethyl alcohol. Its role is paramount in ensuring the proper blending of all components to form the acid and alkali-resistant and thermostabilized AMP.

In accordance with a third aspect of the present invention, the applications of the AMP are provided.

The preservative, detailed herein, is formulated using the acid and alkali-resistant and thermostabilized AMP, as described above. It offers a safe and effective solution for extending the shelf life of various products, including but not limited to food items.

The core of this preservative's efficacy lies in the incorporation of the acid and alkali-resistant and thermostabilized AMP. As previously elucidated, this peptide is engineered to maintain its native conformation even under adverse conditions, such as extreme pH levels and temperature variations. This inherent stability is a vital attribute when applied to food preservation.

The resultant acid and alkali-resistant, thermostabilized, and non-toxic preservative offers numerous advantages for the food industry. It effectively inhibits the growth of spoilage microorganisms and pathogenic bacteria, thus extending the freshness and safety of food products. Furthermore, it achieves these preservative qualities without introducing harmful or toxic components, making it a safe choice for consumption.

This preservative's versatile nature allows for its integration into a wide range of food products. It can be employed in various forms, including liquids, powders, coatings, or encapsulated forms, depending on the specific application and desired release characteristics. The preservative's controlled release properties, stemming from the encapsulation of the AMP, ensure a sustained antimicrobial effect over time, further enhancing its effectiveness.

Moreover, the preservative's non-toxic nature makes it an appealing choice for clean-label and health-conscious food products. It aligns with the growing consumer demand for natural and safe food additives while simultaneously addressing the critical issue of food spoilage and safety.

In a similar vein, this acid and alkali-resistant, thermostabilized, and non-toxic preservative finds utility as a food additive. In this capacity, it elevates food products by enhancing their shelf life, safety, and overall quality. The inclusion of this preservative in food formulations empowers manufacturers to meet consumer expectations for safe, fresh, and minimally processed products.

In conclusion, the acid and alkali-resistant, thermostabilized, and non-toxic preservative, formulated using the disclosed AMP, presents a pioneering solution to the challenges of food preservation and quality enhancement. Its versatility, stability, and safety profile make it a valuable asset to the food industry, offering opportunities for clean-label products and addressing critical concerns related to food safety and waste reduction.

### EXAMPLES

In the following examples, one of commercially available AMP, nisin, is used as a demonstrating example. Nisin, denoted by FDA (Food and Drug Administration) approved E number, E234, is not widely used in industries as preservatives due to its limited antimicrobial spectrum, weaken antimicrobial effect upon pH, temperature and enzymatic reactions.

### Example 1. Methods for Binding Structure-Lock Components to Nisin

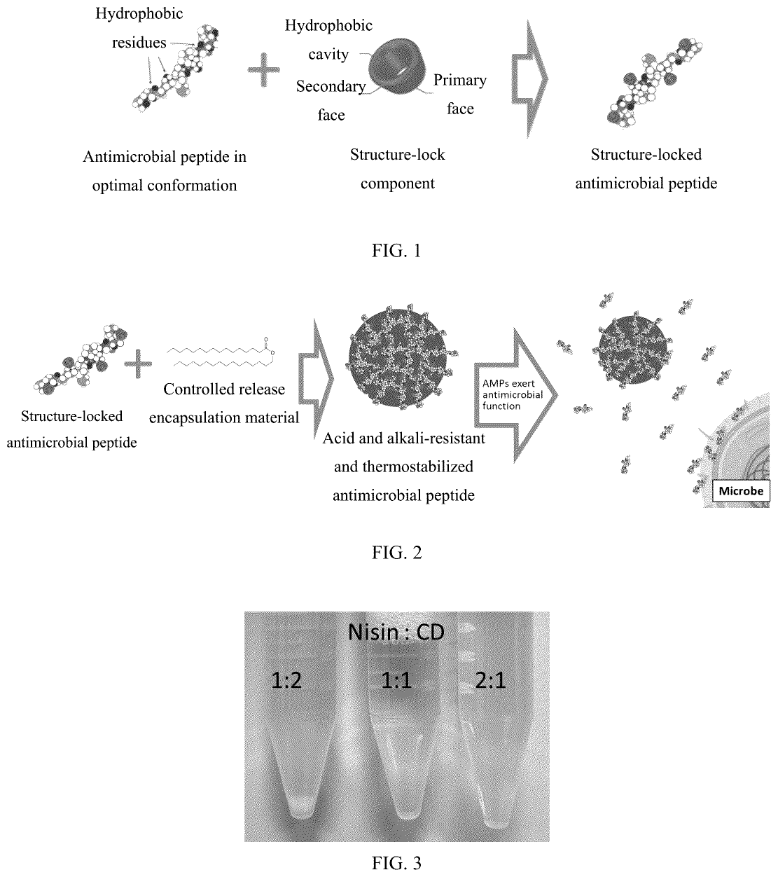

The peptide chain structure of nisin is sensitive to pH and temperature variations and severely affects its high antimicrobial activity; therefore, the structure-lock component is introduced to nisin for binding the molecules on the peptide chain and locks the peptide in a desired orientation, thereby, restricts secondary and tertiary structural change of peptides upon changes in pH and temperatures. FIG. 1 illustrates the binding of molecules on peptide chain through structure-lock protection. In this example, cyclodextrin is chosen as the sturcuture-lock component.

1 g of nisin and 1 g of cyclodextrin are dissolved in 98 mL of deionised water. The mixture is stirred for varying durations: 2 hrs, 4 hrs, 6 hrs, 8 hrs and overnight. β-cyclodextrin is used in this process, creating a slightly acidic solution with a pH of approximately 5. Different ratio of nisin and cyclodextrin (2:1, 1:1 and 1:2) are prepared.

Table 1 demonstrates that the particle size increases with longer stirring times. The particle size fluctuates from 44 nm to 895 nm, with PDI values exceeding 0.5 when stirring times range from 0 hours to 8 hours. However, after overnight stirring (24 hours), the particle size stabilizes at 694 nm, and the PDI falls below 0.5. Similar results are observed in samples with different nisin-to-cyclodextrin ratios. Therefore, to achieve a stable homogeneous solution, all samples are stirred overnight, unless otherwise specified in the procedures.

TABLE 1
The particle size of nisin and β-cyclodextrin
with different mixing time and ratio.

| | Number | |
|---|---|---|
| | Mean | |
| | (nm) | PDI |
| 1% Nisin:β-Cyclodextrin (1:1)_ 0 hr | 147 | 0.61 |
| 1% Nisin:β-Cyclodextrin (1:1)_ 2 hr | 297 | 0.65 |
| 1% Nisin:β-Cyclodextrin (1:1)_ 4 hr | 129 | 0.64 |
| 1% Nisin:β-Cyclodextrin (1:1)_ 6 hr | 44 | 0.49 |
| 1% Nisin:β-Cyclodextrin (1:1)_ 8 hr | 895 | 0.51 |
| 1% Nisin:β-Cyclodextrin (1:1)_ 24 hr | 694 | 0.47 |
| 1% Nisin:β-Cyclodextrin (2:1)_ 0 hr | 280 | 0.63 |
| 1% Nisin:β-Cyclodextrin (2:1)_ 24 hr | 655 | 0.43 |
| 1% Nisin:β-Cyclodextrin (1:2)_ 0 hr | 284 | 0.46 |
| 1% Nisin:β-Cyclodextrin (1:2)_ 24 hr | 781 | 0.46 |

FIG. 3 illustrates the appearance of nisin: β-cyclodextrin solutions in different ratios. The findings demonstrate that nisin to β-cyclodextrin ratios of 2:1, 1:1, and 1:2 result in similar particle sizes. However, when the nisin-to-cyclodextrin solution has a ratio of 1:2, it exhibits insoluble excess β-cyclodextrin at the bottom. Consequently, the 1:2 ratio solution is not selected for use in subsequent experiments. For convenience, a 1:1 ratio of nisin to cyclodextrin is employed for the following experiments.

To assess the binding between cyclodextrin and nisin, thin-layer chromatography (TLC) is conducted. TLC is an affinity-based chromatography technique employed to separate and identify compounds within solution mixtures. Compounds in mixtures are separated between a fixed stationary phase and a liquid mobile phase based on their differential affinities for these phases, influencing the migration speed of individual compounds. Consequently, each compound has a distinct and unique retention factor (R_{f}) value. TLC is valued for its versatility, simplicity, high sensitivity, relatively low cost, rapid development time, and reproducibility.

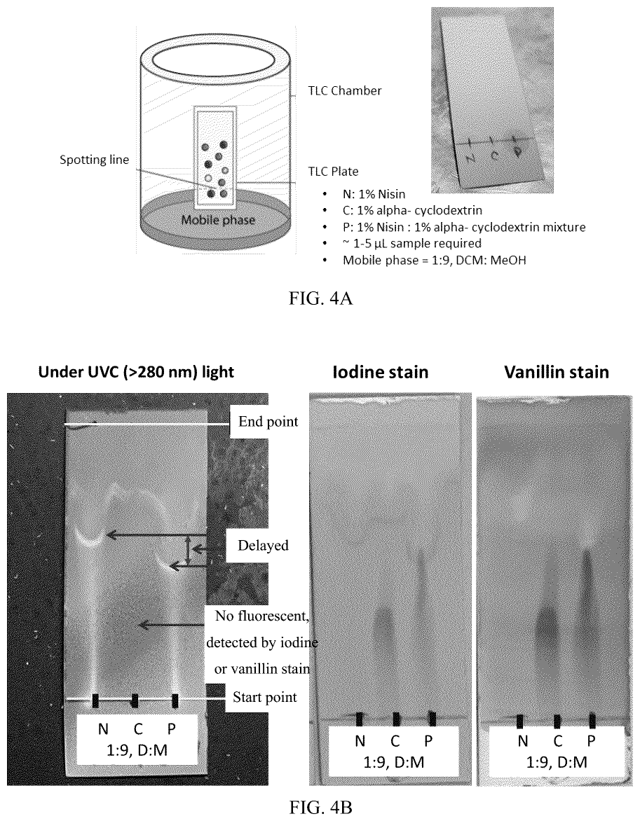

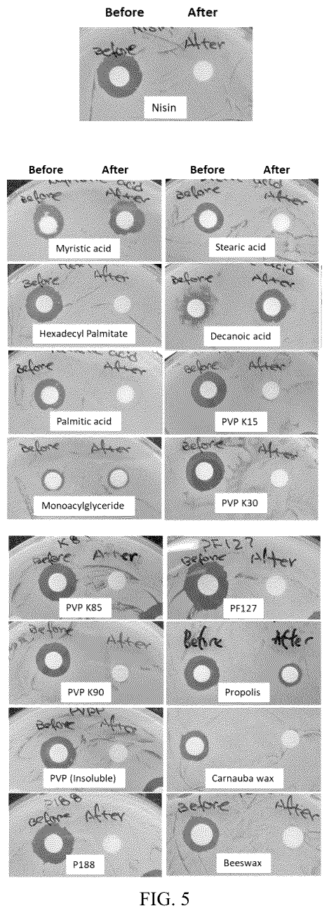

In brief, a TLC plate coated with silica is used. Approximately 1-5 μL of the sample is spotted on the designated line, and the plate is immersed in a liquid mobile phase containing a solvent system (optimized to 1:9, dichloromethane:methanol) within a TLC chamber. The plate is allowed to develop until the solvent front reaches the upper end of the TLC plate, at which point the solvent front is marked. Subsequently, the TLC plate is examined under UVA and UVC light to detect fluorescent compounds. To further identify compound spot(s) that are not active under UV light, the TLC plate is stained with iodine followed by vanillin. The R_{f} value of each compound is calculated by dividing the distance traveled by the compound by the distance traveled by the solvent. FIGS. 4A and 4B respectively depict the TLC setup and TLC plates stained with iodine and vanillin.

The R_{f} value of nisin, cyclodextrin and mixtures are calculated and listed in Table 2. The results reveal that the R_{f} values of the nisin-cyclodextrin mixture differ from those of nisin and cyclodextrin alone, indicating the successful binding of cyclodextrin to nisin.

TABLE 2
The R_{f} values of nisin, various cyclodextrins
as well as nisin-cyclodextrin mixtures.

| | Retention factor (R_{f}) value: | | | |
|---|---|---|---|---|
| | 1% | 1% Cyclo- | | Mixture/ |
| Sample: | Nisin | dextrin | Mixture | Nisin |
| 1% Nisin | 0.6 | — | — | — |
| 1% Nisin:α-Cyclodextrin (1:1) | 0.6 | 0.45 | 0.58 | 97% |
| 1% Nisin:β-Cyclodextrin (1:1) | 0.6 | 0.31 | 0.51 | 85% |
| 1% Nisin:γ-Cyclodextrin (1:1) | 0.6 | 0.29 | 0.42 | 70% |
| 1% Nisin:2-Hydroxyproyl-β- | 0.6 | 0.71 | 0.57 | 95% |
| cyclodextrin (1:1) | | | | |
| 1% Nisin:2-Hydroxyproyl-γ- | 0.6 | 0.68 | 0.55 | 92% |
| cyclodextrin (1:1) | | | | |
| 1% Nisin:Methyl-β-cyclodextrin | 0.6 | 0.66 | 0.51 | 85% |
| (1:1) | | | | |
| 1% Nisin:β | 0.6 | 0.4 | 0.26 | 43% |
| Cyclodextrin/epichlorohydrin | | | | |
| copolymer (1:1) | | | | |
| 1% Nisin:Sulfobutyl ether β- | 0.6 | 0.69 | 0.49 | 82% |
| cyclodextrin sodium (1:1) | | | | |

### Example 2. Protection Effect of Cyclodextrin on Nisin

The examination of pH effects on the physical properties of nisin involves measuring the particle size of nisin solutions at different pH values (pH 4, 7, and 10). The particle sizes are currently 185 nm, 711 nm, and 450 nm at pH 4, 7, and 10, respectively. These changes in particle size within acidic (pH 4), neutral (pH 7), and basic (pH 10) environments indicate that the degree of protonation of the amino residues on the peptide chain causes variations in the twisting angle of the peptide chain. Comparing the percentage changes in particle size of nisin-cyclodextrin mixtures at pH 4 and 7 reveals the effective protective and/or restricting effect of cyclodextrin. Samples with major particle sizes exceeding 1000 nm at different pH levels are excluded at this stage.

The procedure for preparing nisin-cyclodextrin solutions in different pH environments is as follows: 1 g of nisin and 1 g of cyclodextrin are dissolved in 98 mL of deionized water, and the mixture is stirred overnight. The resulting sample(s) is then freeze-dried, resulting in a powder. This powder is dissolved in different pH solutions (pH 4, 7, and 10), and the particle sizes of the samples are measured using a Zeta-sizer.

Table 3 illustrates that the major (number mean) particle sizes of α-cyclodextrin, γ-cyclodextrin, methyl-β-cyclodextrin, β-cyclodextrin/epichlorohydrin copolymer, and ε-poly-L-lysine are all smaller than 1000 nm under different pH conditions, making these materials suitable candidates for subsequent experiments.

TABLE 3
The particle sizes of nisin-cyclodextrin mixture at pH 4, 7 and 10.

| | pH 4 | | pH 7 | | | pH 10 | | |
|---|---|---|---|---|---|---|---|---|
| | Number | | Number | | | Number | | |
| Sample | Mean (nm) | PDI | Mean (nm) | PDI | Change | Mean (nm) | PDI | Change |
| 1% Nisin | 185 | 0.69 | 711 | 0.51 | 384% | 450 | 0.58 | 243% |
| 1% Nisin:α-Cyclodextrin (1:1) | 302 | 0.68 | 462 | 0.97 | 153% | 848 | 0.54 | 281% |
| 1% Nisin:β-Cyclodextrin (1:1) | 640 | 0.64 | 1970 | 0.33 | 308% | 835 | 0.44 | 130% |
| 1% Nisin:γ-Cyclodextrin (1:1) | 719 | 0.41 | 953 | 0.57 | 133% | 603 | 0.62 | 84% |
| 1% Nisin:2-Hydroxyproyl-β- | 188 | 0.72 | 305 | 0.48 | 162% | 1313 | 0.53 | 699% |
| cyclodextrin (1:1) | | | | | | | | |
| 1% Nisin:2-Hydroxyproyl-γ- | 292 | 0.65 | 1529 | 0.48 | 523% | 1844 | 0.39 | 631% |
| cyclodextrin (1:1) | | | | | | | | |
| 1% Nisin:Methyl-β-cyclodextrin (1:1) | 265 | 0.85 | 296 | 0.51 | 112% | 231 | 0.63 | 87% |
| 1% Nisin:β Cyclodextrin/ | 293 | 0.75 | 868 | 0.41 | 297% | 372 | 0.54 | 127% |
| epichlorohydrin copolymer (1:1) | | | | | | | | |
| 1% Nisin:Sulfobutyl ether β- | 1843 | 0.35 | 2073 | 0.33 | 112% | 1303 | 0.42 | 71% |
| cyclodextrin sodium (1:1) | | | | | | | | |
| 1% Nisin:Zein proteins (1:1) | Not soluble of Zein in water | | | | | | | |
| 1% Nisin:ε-Poly-L-lysine (1:1) | 184 | 0.63 | 886 | 0.40 | 482% | 16 | 0.88 | 9% |
| 1% Nisin:Silk fibroin (1:1) | 1552 | 0.95 | 1694 | 0.52 | 110% | 2772 | 0.68 | 181% |
| 1% Nisin:Silk sericin (1:1) | 1552 | 0.37 | 1217 | 0.17 | 78% | 1193 | 0.12 | 77% |

### Example 3. The Antimicrobial Properties of the Structural-Locked AMP

The antibacterial properties of the formulations are screened and assessed using the inhibition zone test method, followed by the plate count method to determine their antibacterial efficacy.

To perform the zone of inhibition test, 0.2 g of freeze-dried nisin: cyclodextrin powder is dissolved in 9.8 g of pH 4, 7, and 10 solutions, respectively, and stirred overnight. The particle sizes of the resulting solutions are listed in Table 3.

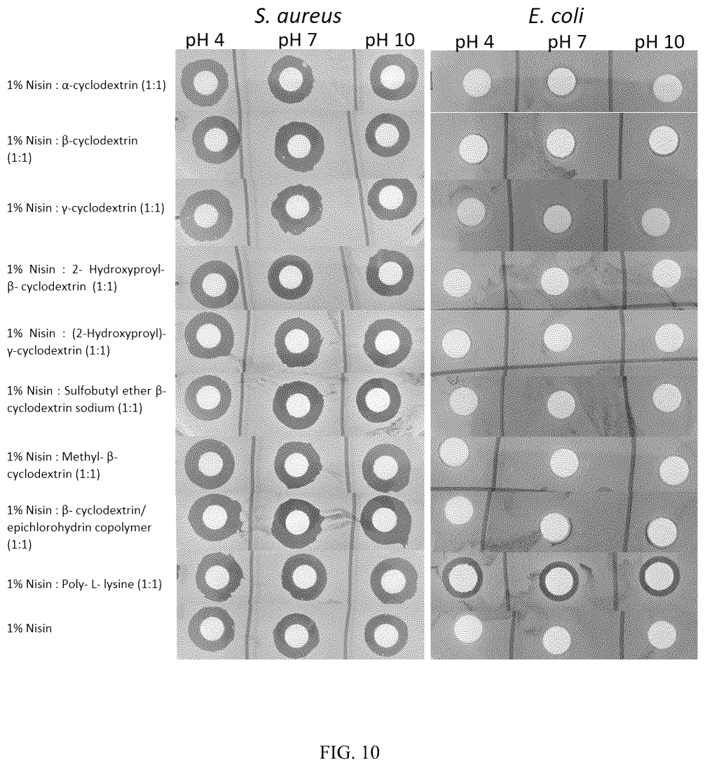

In the zone of inhibition test, the pH-treated formulations are inoculated separately onto nutrient agar plates containing cultured S. aureus and E. coli. A volume of 100 μL of S. aureus or E. coli solution is added to the agar plates and spread evenly using a spreader. Subsequently, 20 μL of the formulation solution is loaded onto a 6 mm sterile disc, and the disc(s) are placed on the surface of the agar plates inoculated with S. aureus or E. coli. These agar plates are then incubated overnight at 37° C., and the resulting clear zones of inhibition are recorded and depicted in FIG. 10.

Regarding the plate count method, solutions of S. aureus and E. coli are prepared and diluted to a concentration of 10⁷ cfu/mL. A volume of 0.2 mL of S. aureus and E. coli solution is added to 1.8 mL of pH-treated nisin: cyclodextrin formulation solutions and vortexed for even distribution of bacteria within the solution. The mixture is incubated for 30 minutes at room temperature. Following this incubation, 100 μL of each mixture is collected, and serial dilutions ranging from 10 to 100,000-fold are performed. Blank samples are also included both before and after the 30-minute incubation period. Subsequently, 100 μL of all diluted samples are evenly spread on agar plates and incubated at 37° C. overnight. The colonies formed on the plate(s) are then counted and recorded. The results are summarized in Table 4.

TABLE 4
Antibacterial results of nisin:cyclodextrin formulation against S. aureus.

| | pH 4 | | pH 7 | | pH 10 | |
|---|---|---|---|---|---|---|
| | Log 5.65 cfu/mL | | Log 5.51 cfu/mL | | Log 5.93 cfu/mL | |
| | Recovered | | Recovered | | Recovered | |
| | bacteria | | bacteria | | bacteria | |
| | from sample | Log | from sample | Log | from sample | Log |
| Blank | (log, cfu/mL) | reduction | (log, cfu/mL) | reduction | (log, cfu/mL) | reduction |
| 1% Nisin | 3.40 | 2.26 | 3 | 2.51 | 3.00 | 2.93 |
| 1% Nisin:α-cyclodextrin (1:1) | 3.38 | 2.27 | 2.85 | 2.66 | 2.60 | 3.33 |
| 1% Nisin:β-cyclodextrin (1:1) | 3.41 | 2.24 | 2 | 3.51 | 2.30 | 3.63 |
| 1% Nisin:γ-cyclodextrin (1:1) | 2.95 | 2.70 | 2 | 3.51 | 2.00 | 3.93 |
| 1% Nisin:2-Hydroxyproyl -β- | 3.30 | 2.35 | 2.60 | 2.90 | 2.30 | 3.63 |
| cyclodextrin (1:1) | | | | | | |
| 1% Nisin:(2-Hydroxyproyl)-γ- | 3.41 | 2.24 | 2.48 | 3.03 | 2.00 | 3.93 |
| cyclodextrin (1:1) | | | | | | |
| 1% Nisin:Sulfobutyl ether β- | 3.32 | 2.33 | 2.30 | 3.20 | 2.30 | 3.63 |
| cyclodextrin sodium (1:1) | | | | | | |
| 1% Nisin:Methyl-β- | 3.08 | 2.57 | 2.70 | 2.81 | 0.00 | 5.93 |
| cyclodextrin (1:1) | | | | | | |
| 1% Nisin:β cyclodextrin/ | 3.28 | 2.37 | 2.70 | 2.81 | 2.30 | 3.63 |
| epichlorohydrin copolymer (1:1) | | | | | | |
| 1% Nisin:ε-poly-L-lysine (1:1) | 3.26 | 2.40 | 2.30 | 3.20 | 3.23 | 2.70 |

At the same concentration (1%) under the same contact killing time (30 minutes), the current antibacterial results of the nisin: cyclodextrin formulation against S. aureus reveal that the combination of nisin with various cyclodextrins increases the antibacterial effect in comparison to unformulated nisin. This phenomenon is attributed to the improved and increased stability, solubility, and permeability of nisin as it interacts with cyclodextrin.

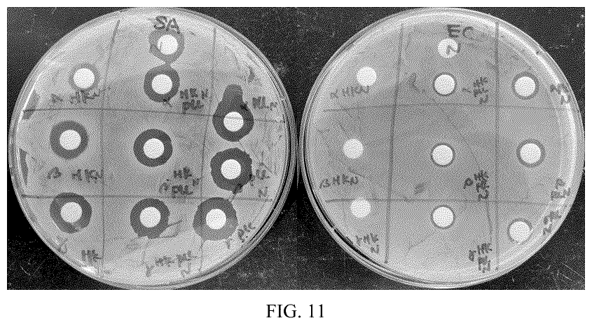

However, gram-negative bacteria such as E. coli exhibit resistance to nisin due to poor adhesion and penetration between nisin and the bacteria's outer membrane. Previous studies have indicated that metal chelators, such as citric acid and phytic acid (G. Zhao et al., Food Control, 2023), enhance the antibacterial effect of nisin against gram-negative bacteria (I. J. G. Márquez et al., Can J Microbiol, 2020). It has also been reported that honokiol has similar functions to these metal chelators and is capable of chelating with Fe (II) ions (S. Kantham et al., Neurosci, 2017). Similarly, Poly-L-lysine, as a peptide, possesses the ability to chelate metal ions. Consequently, both honokiol and Poly-L-lysine are added to the formulation to enhance the bacterial membrane adhesion of nisin, promoting penetration and subsequently initiating cytoplasmic leakage, thereby achieving maximum antibacterial effectiveness. The antimicrobial effect against E. coli upon the incorporation of honokiol and Poly-L-lysine is currently being assessed, and the results are being summarized in Table 5, with the zone of inhibition test images displayed in FIG. 11.

TABLE 5
Antibacterial effects of the formulations including honokiol
and poly-L-lysine against S. aureus and E. coli.

| | Antibacterial effect | |
|---|---|---|
| | S. aureus | E. coli |
| 1% Nisin | □ | X |
| 1% Nisin:α-cyclodextrin:Honokiol (1:10.1) | □ | X |
| 1% Nisin:β-cyclodextrin:Honokiol (1:1:0.1) | □ | X |
| 1% Nisin:γ-cyclodextrin:Honokiol (1:1:0.1) | □ | X |
| 1% Nisin:α-cyclodextrin:poly-L-lysine (1:1:1) | □ | □ |
| 1% Nisin:β-cyclodextrin:poly-L-lysine (1:1:1) | □ | □ |
| 1% Nisin:γ-cyclodextrin:poly-L-lysine (1:1:1) | □ | □ |
| 1% Nisin:α-cyclodextrin:poly-L-lysine:Honokiol | □ | □ |
| (1:1:0.5:0.05) | | |
| 1% Nisin:β-cyclodextrin; poly-L-lysine:Honokiol | □ | □ |
| (1:1:0.5:0.05) | | |
| 1% Nisin:γ-cyclodextrin:poly-L-lysine:Honokiol | □ | □ |
| (1:1:0.5:0.05) | | |

### Example 4. The Encapsulation of the Structural-Locked AMP

Encapsulation is a process of enclosing and/or entrapping one substance within another substance to form particles or capsules. Solid lipids, polyvinylpyrrolidones (PVP) and natural waxes are commonly used encapsulation materials. Solid lipids are a class of lipids with high melting points and are solid at room temperature. They can be used as matrix materials for encapsulation of bioactive compounds and/or drugs to improve their stability, bioavailability, and controlled release properties. Whereas PVP is a water-soluble polymer commonly used as coating agent and/or encapsulating agent for various applications. PVP has a high molecular weight, non-toxic and is biocompatible, making it suitable for use in biomedical and pharmaceutical applications. Natural waxes are complex mixtures of lipids derived from plants, animals, or microorganisms. They have a high melting point and are solid at room temperature, thus, they are suitable for use as encapsulating materials. The encapsulation of structural-locked AMP is depicted in FIG. 2.

One of the suitable methods for fabricating PVP nanoparticles is as follows. Briefly, 1 g of nisin and 1 g of PVP are dissolved in 98 mL of deionized water and stirred overnight to obtain a homogeneous solution. Then, 1 mL of the resultant homogeneous solution is introduced into a 1.5 mL microcentrifuge tube for later antibacterial testing. To this homogeneous solution, 10 mg/mL of protease is added, and the mixture is incubated at 37° C. overnight to enzymatically digest the nisin in the solution. After incubation, 20 μL of the treated solution is transferred to a 6 mm sterile disc and placed on an agar plate inoculated with S. aureus, along with samples that have not undergone enzymatic treatment. The inoculated agar plates containing the samples are then incubated at 37° C. overnight.

For solid lipids and natural waxes, 1 g of solid lipid or wax is added to 49 g of ethanol and heated at 70-80° C. with stirring at 400 rpm until all solid lipid or wax has dissolved. Simultaneously, 1 g of nisin is dissolved in 49 g of deionized water. The lipid or wax-ethanol solution is added dropwise with vigorous stirring into the nisin solution and stirred for an additional 30 minutes. The resulting mixture turns into a milky color. Then, 1 mL of the sample is transferred into a 1.5 mL microcentrifuge tube for later antibacterial testing. To this solution, 10 mg/mL of protease is added, and it is incubated at 37° C. overnight to enzymatically digest the nisin in the solution. After incubation, the sample is heat-treated to release the nisin entrapped in the nanoparticles. Subsequently, an antibacterial test is performed by adding 20 μL of the treated solution to a 6 mm sterile disc, which is placed on an agar plate inoculated with S. aureus alongside samples that have not undergone treatment. The plates are then incubated at 37° C. overnight.

The zones of inhibition for each sample are measured and recorded, with zones of inhibition larger than the sterile disc (6 mm) by 1 mm indicating antimicrobial activity. The results of the zone of inhibition test are summarized in Table 6, and images of the zone of inhibition tests are displayed in FIG. 5.

TABLE 6
The protection effect of solid lipids, natural waxes and polymers

| | Antibacterial effect | |
|---|---|---|
| | Before | After |
| | protease | protease |
| | digestion | digestion |
| Nisin | □ | X |
| Nisin + Myristic acid | □ | □ |
| Nisin + Hexadecyl Palmitate | □ | X |
| Nisin + Palmitic acid | □ | X |
| Nisin + Monoacylglyceride | □ | □ |
| Nisin + Stearic acid | □ | X |
| Nisin + Decanoic acid | □ | □ |
| Nisin + Polyvinylpyrrolidone K15, MW10000 | □ | X |
| Nisin + Polyvinylpyrrolidone K30, MW40000 | □ | X |
| Nisin + Polyvinylpyrrolidone K90, MW360000 | □ | X |
| Nisin + Polyvinylpyrrolidone K85-95, | □ | X |
| MW1300000 | | |
| Nisin + Polyvinylpyrrolidone (Insoluble) | □ | X |
| Nisin + Poloxamer 188, Average MW 8400 | □ | X |
| Nisin + Pluronic ® F127 | □ | X |
| Nisin + Propolis | □ | □ |
| Nisin + Carnauba wax | □ | X |
| Nisin + Beeswax | □ | X |

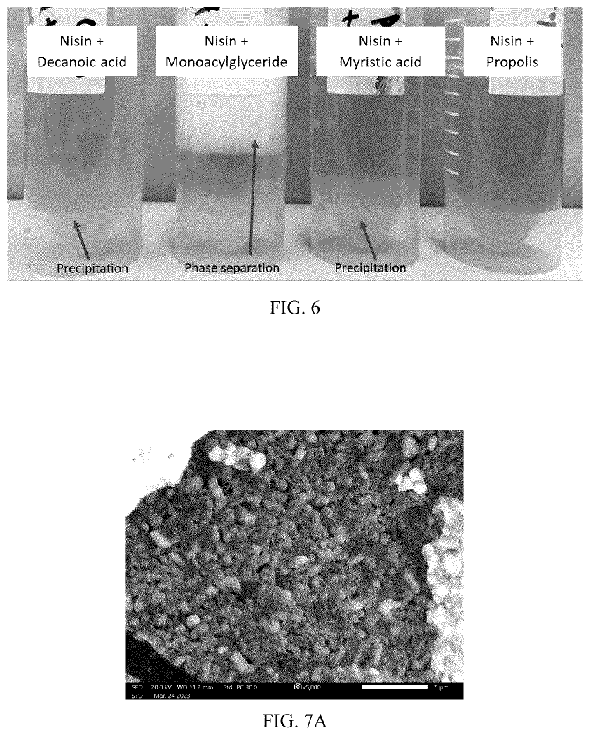

Out of the 17 antibacterial tests conducted, nisin in combination with myristic acid, monoacylglyceride, decanoic acid, or propolis exhibits antibacterial effects after protease digestion. In contrast, other combinations do not display antibacterial effects following protease digestion. These results suggest that the combinations of nisin with myristic acid, monoacylglyceride, decanoic acid, or propolis are capable of partially and/or fully encapsulating and/or entrapping nisin. While myristic acid and decanoic acid lead to precipitation of the resulting solution (as shown in FIG. 6), this issue can be addressed, optimized, and further developed through formulation and processes in subsequent stages. On the other hand, the combination of nisin with propolis does not result in precipitation, and the zone of inhibition only exhibits a slight reduction after protease digestion.

### Example 5. The Physical Properties of the Encapsulated and Structural-Locked AMP

To prepare a 10% propolis ethanol extract, 1 g of propolis is dissolved in 9 g of ethanol, and the mixture is sonicated for at least 60 minutes to ensure complete dissolution. The suspension is then filtered through qualitative filter paper to remove large debris. Subsequently, the filtrate undergoes further filtration using a 0.45 μm nylon or PTFE syringe filter. The resulting filtrate, constituting the 10% propolis ethanol extract, is collected and stored at room temperature for subsequent experiments.

In another experiment, a light pale yellow homogenous solution is prepared by dissolving 1 g of nisin, 1 g of cyclodextrin, and 1 g of poly-L-lysine in 96 g of deionized water. This solution is stirred overnight to ensure thorough mixing. The particle size of nisin/poly-L-lysine with different cyclodextrins is measured using a zeta-sizer, and the results are presented in Table 7

TABLE 7
Particle sizes of nisin/poly-L-lysine with different cyclodextrins

| | Number | |
|---|---|---|
| | Mean | |
| Sample: | (nm) | PDI |
| 1% Nisin:α-Cyclodextrin:poly-L-lysine (1:1:1) | 460 | 0.48 |
| 1% Nisin:β-Cyclodextrin:poly-L-lysine (1:1:1) | 426 | 0.77 |
| 1% Nisin:γ-Cyclodextrin:poly-L-lysine (1:1:1) | 653 | 0.87 |
| 1% Nisin:α-Cyclodextrin:poly-L-lysine:Propolis | 645 | 0.38 |
| (1:1:1:0.1) | | |
| 1% Nisin:Methyl-β-cyclodextrin:Propolis (1:1:1) | 35 | 0.33 |
| 1% Nisin:β Cyclodextrin/ epichlorohydrin | 908 | 0.26 |
| copolymer:Propolis (1:1:1) | | |

The results indicate that only samples containing 1% nisin: α-cyclodextrin: poly-L-lysine (1:1:1) exhibit a PDI less than 0.5. Consequently, this formulation is chosen for the incorporation of propolis extract to maximize its antibacterial effect. In a nutshell, 1 g of 10% propolis ethanol extract is added dropwise to a solution consisting of 99 g of nisin/cyclodextrin/poly-L-lysine with vigorous stirring. Propolis extract is also incorporated into 1% nisin:methyl-β-cyclodextrin and 1% nisin:β-cyclodextrin/epichlorohydrin copolymer to form nanoparticles. The particle sizes are measured using a zeta-sizer, and the results are presented in Table 7.

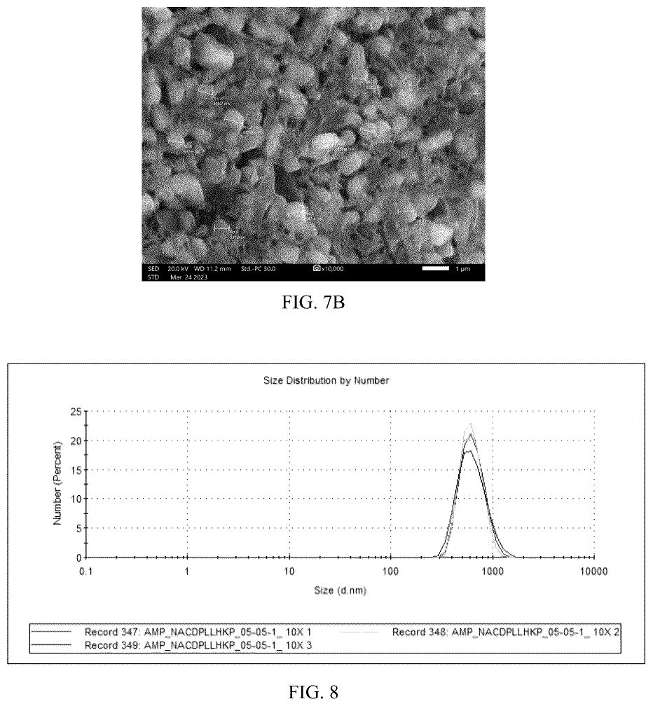

To examine the morphology of the nanoparticles, scanning electron microscopy (SEM) is employed. The nisin/cyclodextrin/poly-L-lysine/propolis solution is freeze-dried to obtain a powdered form. This powder is then transferred onto a silicon wafer, adhered to the copper mount surface using carbon conductive tape. A thin layer of gold is deposited on the powder surface to enhance sample conductivity. High-resolution images are captured using SEM. As depicted in FIG. 7, the images reveal the presence of nanoparticles with sizes approximately around 600 nm. Additionally, the SEM images show a thin layer surrounding the nanoparticles, which may correspond to the uncapsulated nisin/cyclodextrin/poly-L-lysine. These uncapsulated materials act as antibacterial agents prior to the release of encapsulated antibacterial agents from the propolis-encapsulated nanoparticles.

### Example 6. Fabricating an Acid and Alkali-Resistant and Thermostabilized Antimicrobial Peptide Sample, AMP_NACDPLLHKP_05-05-1

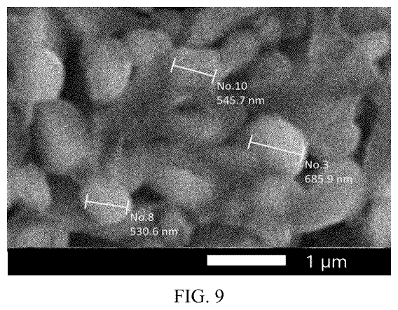

To create AMP_NACDPLLHKP_05-05-1, the following steps are performed: 1 g of nisin, 1 g of α-cyclodextrin, 0.5 g of poly-L-lysine, and 0.5 g of honokiol are dissolved in 96 g of deionized water. This mixture is stirred overnight, resulting in a light pale yellow homogeneous solution. Subsequently, 1 g of 10% propolis ethanol extract is added dropwise to the 99 g nisin/cyclodextrin/poly-L-lysine solution, and the solution is vigorously stirred, leading to a milky appearance. The formulation details are summarized in Table 8. A portion of the solution is diluted tenfold and transferred into a cuvette for particle size measurements using a zeta-sizer. The recorded particle sizes are listed in Table 9, and the particle distribution curve is depicted in FIG. 8. The remaining part of the solution is freeze-dried to obtain a powdered form for SEM examination. The nanostructure of AMP_NACDPLLHKP_05-05-1 is illustrated in FIG. 9.

TABLE 8
Formulation of AMP_NACDPLLHKP_05-05-1

| | Percentage | Percentage |
|---|---|---|
| Ingredient | (liquid form) | (powder form) |
| Nisin | 1% | 37.7% |
| α-Cyclodextrin | 1% | 37.7% |
| poly-L-lysine | 0.5% | 18.9% |
| Propolis extract | 0.1% | 3.8% |
| Honokiol | 0.05% | 1.9% |
| Ethanol | 1% | — |
| Di Water | 96.35% | — |

TABLE 9
Particle sizes of AMP_NACDPLLHKP_05-05-1

| | Main | |
|---|---|---|
| | size | |
| | (nm) | PDI |
| Sample-1 | 648.9 | 0.425 |
| Sample-2 | 630.3 | 0.328 |
| Sample-3 | 655.0 | 0.388 |
| Average: | 644.7 | 0.380 |

The results reveal that the particle size of AMP_NACDPLLHKP_05-05-1 is consistently below 1000 nm, and the polydispersity remains under 0.5.

To further assess the stability of the AMP sample, freeze-dried AMP_NACDPLLHKP_05-05-1 solution is subjected to an environmental chamber set at 40° C. and 75% relative humidity (RH) for 3 months. This test aims to simulate a shelf life of 2 years for the product. The particle sizes and antibacterial effects of the AMP_NACDPLLHKP_05-05-1 sample are measured at 0, 1, and 2 months (Table 10). Additionally, the particle sizes at the 3-month time point are measured, and the antibacterial effect is assessed using the plate-count method.

TABLE 10
Particle sizes of AMP_NACDPLLHKP_05-
05-1 under acceleration conditions.

| | Number | |
|---|---|---|
| | Mean | |
| Sample: | (nm) | PDI |
| AMP_NACDPLLHKP_05-05-1_0 month | 645 | 0.38 |
| AMP_NACDPLLHKP_05-05-1_1 month | 751 | 0.29 |
| AMP_NACDPLLHKP_05-05-1_2 months | 703 | 0.33 |
| AMP_NACDPLLHKP_05-05-1_3 months | 701 | 0.48 |

### Example 7. The Antimicrobial Effect of AMP_NACDPLLHKP_05-05-1 in acidic environment (pH 4) in accordance to Technical Standard of Disinfectant 2002

Antibacterial tests are performed following Technical Standard of Disinfectant 2002 method tested with S. aureus and E. coli. 2 mL of AMP_NACDPLLHKP_05-05-1 solution (equal to 1% nisin active) and 2 mL of 1% nisin are transferred into 15 mL sterile falcon tube separately, and freeze-dried for three days to obtain freeze-dried powder. 1.8 mL of pH 4 solution is added into the freeze-dried powders and mixed homogenously overnight to obtain pH 4 treated AMP_NACDPLLHKP_05-05-1 solution and nisin solution. S. aureus and E.colisolution are prepared and diluted to ˜107 cfu/mL. 0.2 mL of S. aureus or E. coli solution is added into 1.8 mL pH treated AMP_NACDPLLHKP_05-05-1 solution and nisin solution, vortexed for even distribution of bacteria inside the solution. The mixtures are incubated for 30 minutes at room temperature with agitation. After 30 minutes incubation, 100 μL of bacteria-loaded solution is collected and serially diluted from 10 to 100,000 folds. Blank sample is also included in the study before and after 30 minutes incubation. 100 μL of diluted samples are spread evenly on inoculated agar plate, and the inoculated agar plates are incubated at 37° C. overnight. The colonies formed on the plate are counted and recorded. The results are summaries in the Table 11.

TABLE 11
The antibacterial results of AMP_NACDPLLHKP_05-05-1 against E. coli and S. aureus
at pH 4 condition in accordance to testing method of Technical Standard of Disinfectant 2002

| | | pH 4 | | | |
|---|---|---|---|---|---|
| | | E. coli | | S. aureus | |
| | | Recovered | | Recovered | |
| | | bacteria | | bacteria | |
| | | from sample | Log | from sample | Log |
| | | (log, cfu/mL) | reduction | (log, cfu/mL) | reduction |
| Trial-1 | Blank | 6.45 | — | 7.03 | — |
| | 1% Nisin | 6.48 | −0.03 | 4.00 | 3.03 |
| | AMP_NACDPLLHKP_05-05-1 | 0.00 | 6.45 | 0.00 | 7.03 |
| Trial-2 | Blank | 6.04 | — | 6.95 | — |
| | 1% Nisin | 5.85 | 0.20 | 3.93 | 3.01 |
| | AMP_NACDPLLHKP_05-05-1 | 0.00 | 6.04 | 0.00 | 6.95 |
| Trial-3 | Blank | 6.08 | — | 7.05 | — |
| | 1% Nisin | 6.30 | −0.22 | 3.97 | 3.08 |
| | AMP_NACDPLLHKP_05-05-1 | 3.30 | 2.78 | 0.00 | 7.05 |

These results reveal that Nisin has a good antibacterial effect against S. aureus; however, no significant antibacterial effect of nisin against E. coli is detected. Furthermore, it is observed that AMP_NACDPLLHKP_05-05-1 has better antibacterial performance against both S. aureus and E. coli. Through comparison of log reduction differences against S. aureus and E. coli S. aureus and E. coli, AMP_NACDPLLHKP_05-05-1 are at least log 5.11 (E. coli) and log 3.97 (S. aureus) better than unformulated nisin.

### Example 8. The Antimicrobial Effect of AMP_NACDPLLHKP_05-05-1 in Neutral (pH 7) and Alkaline (pH 10) Environment in Accordance to Technical Standard of Disinfectant 2002

Antibacterial tests are conducted following the Technical Standard of Disinfectant 2002 methodology and involved testing against S. aureus and E. coli. To prepare for the tests, 2 mL of AMP_NACDPLLHKP_05-05-1 solution (equivalent to 1% nisin activity) and 2 mL of 1% nisin are separately transferred into 15 mL sterile Falcon tubes. These samples are freeze-dried for three days to obtain freeze-dried powder. Subsequently, 1.8 mL of pH 7 or pH 10 solution is added to the freeze-dried powder, and the mixtures are homogenously mixed overnight to obtain pH 7 or pH 10 treated solutions for AMP_NACDPLLHKP_05-05-1 and nisin.

S. aureus and E. coli solutions are prepared and diluted to a concentration of approximately ˜10⁷ colony-forming units per milliliter (cfu/mL). Next, 0.2 mL of the S. aureus and E. coli solution is added to 1.8 mL of the pH-treated AMP_NACDPLLHKP_05-05-1 solution and nisin solution. The mixtures are vortexed to ensure even distribution of bacteria within the solution. These mixtures are then incubated for 30 minutes at room temperature with agitation.

Following the 30-minute incubation, 100 μL of the bacteria-loaded solution is collected and serially diluted from 10 to 100,000-fold. Blank samples are also included both before and after the 30-minute incubation period. Subsequently, 100 μL of the diluted samples are inoculated onto agar plates and spread evenly. These inoculated agar plates are placed in a 37° C. incubator overnight. The colonies formed on the plates are counted and recorded. The results of these tests are summarized in Table 12 (pH 7 treated results) and Table 13 (pH 10 treated results).

TABLE 12
The antibacterial results of AMP_NACDPLLHKP_05-05-1 against E. coli and
S. aureus at pH 7 condition using testing method of Technical Standard of Disinfectant 2002

| | | pH 7 | | | |
|---|---|---|---|---|---|
| | | E. coli | | S. aureus | |
| | | Recovered | | Recovered | |
| | | bacteria | | bacteria | |
| | | from sample | Log | from sample | Log |
| | | (log, cfu/mL) | reduction | (log, cfu/mL) | reduction |
| Trial-1 | Blank | 6.75 | — | 7.03 | — |
| | 1% Nisin | 6.65 | 0.09 | 3.00 | 4.03 |
| | AMP_NACDPLLHKP_05-05-1 | 0.00 | 6.75 | 0.00 | 7.03 |
| Trial-2 | Blank | 5.95 | — | 6.95 | — |
| | 1% Nisin | 6.38 | 0 | 2.78 | 4.17 |
| | AMP_NACDPLLHKP_05-05-1 | 0.00 | 5.95 | 0.00 | 6.95 |
| Trial-3 | Blank | 6.08 | — | 7.05 | — |
| | 1% Nisin | 6.45 | −0.37 | 2.95 | 4.10 |
| | AMP_NACDPLLHKP_05-05-1 | 3.48 | 2.60 | 0.00 | 7.05 |

TABLE 13
The antibacterial results of AMP_NACDPLLHKP_05-05-1 against E. coli and S. aureus
at pH 10 condition using testing method of Technical Standard of Disinfectant 2002

| | | pH 10 | | | |
|---|---|---|---|---|---|
| | | E. coli | | S. aureus | |
| | | Recovered | | Recovered | |
| | | bacteria | | bacteria | |
| | | from sample | Log | from sample | Log |
| | | (log, cfu/mL) | reduction | (log, cfu/mL) | reduction |
| Trial-1 | Blank | 6.76 | — | 7.03 | — |
| | 1% Nisin | 6.72 | 0.05 | 2.60 | 4.43 |
| | AMP_NACDPLLHKP_05-05-1 | 0.00 | 6.76 | 0.00 | 7.03 |
| Trial-2 | Blank | 5.30 | — | 6.95 | — |
| | 1% Nisin | 6.45 | −1.15 | 2.90 | 4.05 |
| | AMP_NACDPLLHKP_05-05-1 | 0.00 | 5.30 | 0.00 | 6.95 |
| Trial-3 | Blank | 6.08 | — | 7.05 | — |
| | 1% Nisin | 6.68 | −0.60 | 3.00 | 4.05 |
| | AMP_NACDPLLHKP_05-05-1 | 3.00 | 3.08 | 0.00 | 7.05 |

These results reveal that nisin exhibits a notable antibacterial effect against S. aureus, while no significant antibacterial effect is observed against E. coli. Conversely, AMP_NACDPLLHKP_05-05-1 demonstrates enhanced antibacterial performance against both S. aureus and E. coli at both pH 7 and pH 10.

Upon comparing the log reduction differences against S. aureus and E. coli after 30 minutes of pH 7 or pH 10 treatment, AMP_NACDPLLHKP_05-05-1 outperforms unformulated nisin by at least log 5.33 (E. coli) and log 2.91 (S. aureus) at pH 7. Similarly, at pH 10, AMP_NACDPLLHKP_05-05-1 exhibits log 5.61 (E. coli) and log 2.84 (S. aureus) improvements compared to unformulated nisin. This represents an enhancement of at least 50% in antibacterial effectiveness (measured in terms of remaining bacteria cfu/mL) for AMP_NACDPLLHKP_05-05-1.

### Example 9. Antimicrobial Effect against E. coli and S. aureus of AMP_NACDPLLHKP_05-05-1 after High Temperature Treatment (90° C. for 15 Minutes) in Accordance to Technical Standard of Disinfectant 2002.

Antibacterial tests are conducted following the Technical Standard of Disinfectant 2002 method, using S. aureus and E. coli as test organisms. Initially, 2 mL of AMP_NACDPLLHKP_05-05-1 solution, equivalent to 1% nisin activity, is transferred into a 15 mL sterile falcon tube. This solution is then freeze-dried for three days to yield freeze-dried powder. Subsequently, 1.8 mL of PBS solution is added to the freeze-dried powders and mixed thoroughly overnight to create a homogeneous AMP_NACDPLLHKP_05-05-1 solution.

Before the antibacterial test commences, half of the AMP_NACDPLLHKP_05-05-1 solution samples undergo heat treatment at 90° C. for at least 15 minutes. S. aureus and E. coli solutions are prepared and diluted to approximately ˜10⁷ cfu/mL. To each of the AMP_NACDPLLHKP_05-05-1 solution samples (both heat-treated and untreated), 0.2 mL of S. aureus or E. coli solution is added. This mixture is vortexed to ensure an even distribution of bacteria within the solution and then incubated for 30 minutes at room temperature with agitation.

Following the 30-minute incubation period, 100 μL of the bacteria-loaded solution is collected and serially diluted by factors ranging from 10 to 100,000. Blank samples are included in the study both before and after the 30-minute incubation. Subsequently, 100 μL of the diluted samples is inoculated onto agar plates and evenly spread. The inoculated agar plates are left to incubate overnight at 37° C., after which the colonies formed on the plates are counted and recorded. The results are summarized in Table 14.

TABLE 14
The antibacterial results of AMP_NACDPLLHKP_05-05-1 against
E. coli and S. aureus before and after heat-treatment condition
using testing method of Technical Standard of Disinfectant 2002

| | | Antibacterial performance | | | |
|---|---|---|---|---|---|
| | | E. coli | | S. aureus | |
| | | Recovered | | Recovered | |
| | | bacteria | | bacteria | |
| | | from | | from | |
| | | sample | | sample | |
| | | (log, | Log | (log, | Log |
| 3 | | cfu/mL) | reduction | cfu/mL) | reduction |
| Before heat- | Trial-1 | 3.30 | 3.52 | 0 | >6 |
| treatment* | Trial-2 | 3.00 | 3.70 | 0 | >6 |
| | Trial-3 | 3.48 | 3.40 | 0 | >6 |
| After heat- | Trial-1 | 3.95 | 2.96 | 0 | >6 |
| treatment* | Trial-2 | 3.95 | 2.96 | 0 | >6 |
| | Trial-3 | 3.78 | 3.10 | 0 | >6 |

The antibacterial results demonstrate that the antibacterial effect of AMP_NACDPLLHKP_05-05-1 against S. aureus and E. coli shows an insignificant change in antibacterial efficacy after subjecting it to 90° C. heat treatment for 15 minutes (Table 14). The alterations in antibacterial efficiency are only 0.53 (E. coli) and 0 (S. aureus), both of which are less than 1 log.

### Example 10. The Antifungal Effect of AMP_NACDPLLHKP_05-05-1

Antifungal testing is conducted in accordance with the international standard EN 1650:2019 at an accredited third-party laboratory (BUREAU VERITAS HONG KONG LIMITED, BV) using as C. albicans and A. brasiliensis as test organisms. To prepare the samples, 1 g of nisin is dissolved in 99 mL of a pH 4 solution and stirred overnight to obtain a homogenous pH 4 treated 1% nisin solution. Subsequently, 100 mL AMP_NACDPLLHKP_05-05-1 solution (equivalent to 1% nisin activity) is transferred into a 100 mL sterile container and subjected to freeze-drying for a duration of three days. The resulted freeze-dried powder is reconstituted by adding it to 100 mL of pH 4 solution and stirring overnight, yielding a pH 4 treated AMP_NACDPLLHKP_05-05-1 solution. Both pH 4 treated samples undergo antifungal testing, and the results are presented in Table 15 and Table 16.

TABLE 15
The antifungal test result of pH 4 treated 1% nisin solution

| | Count of test | Count of test sample |
|---|---|---|
| Test parameter | suspension | at concentration 80% |
| Candida albicans | 1,900,000 | 1,800,000 (log 6.26) |
| (ATCC # 10231) | (log 6.28) | |
| Log reduction | | 0.02 |
| Percent reduction | | 5.26% |
| Aspergillus | 2,100,000 | 930,000 (log 5.97) |
| brasiliensis | (log 6.32) | |
| (ATCC # 16404) | | |
| Log reduction | | 0.35 |
| Percent reduction | | 55.71% |

TABLE 16
The antifungal test result of pH 4 treated
AMP_NACDPLLHKP 05-05-1 solution

| | Count of test | Count of test sample |
|---|---|---|
| Test parameter | suspension | at concentration 80% |
| Candida albicans | 1,900,000 | <10 (<log 1.15) |
| (ATCC # 10231) | (log 6.28) | |
| Log reduction | | >5.13 |
| Percent reduction | | >99.99% |
| Aspergillus | 2,100,000 | 720,000 (log 5.86) |
| brasiliensis | (log 6.32) | |
| (ATCC # 16404) | | |
| Log reduction | | 0.46 |
| Percent reduction | | 65.7% |

The antifungal results demonstrate that unformulated nisin exhibits a slight antifungal effect against C. albicans and A. brasiliensis. In contrast, the formulated nisin, AMP_NACDPLLHKP_05-05-1, displays significantly improved antifungal activity against C. albicans and a slight improvement against A. brasiliensis. Specifically, the antifungal results for AMP_NACDPLLHKP_05-05-1 show a substantial increase, with a difference of log 5.11 (C. albicans) and log 0.11 (A. brasiliensis) compared to unformulated nisin.

### Example 11. Safety Assessments of AMP_NACDPLLHKP_05-05-1

AMP_NACDPLLHKP_05-05-1 is subjected to cell toxicity testing using a human cell line (HaCat) through the MTT assay method, and the results are compared with those of nisin. The quantitative assessment is calculated using the following formula:

$$Viability \text{} ( \% ) = [ OD ( 570 - 650 ) of TA / PC / NC ] / [ OD ( 570 - 650 ) of BC ] * 100 ;$$

and the results are stated in Table 17-Table 19.

TABLE 17
The results of AMP_NACDPLLHKP_05-05-1 (mean ± SD)

| | | Qualitative grading | |
|---|---|---|---|
| Group (V/V) | OD | of cell morphology | Viability (%) |
| Blank control | 0.29 ± 0.03 | 0 | 100.00 ± 8.82 |
| Negative control | 0.30 ± 0.03 | 0 | 102.78 ± 11.22 |
| Positive control | 0.02 ± 0.00 | 4 | 7.43 ± 1.46 |
| 10% | 0.02 ± 0.00 | 4 | 6.28 ± 1.00 |
| 1% | 0.23 ± 0.03 | 1 | 80.61 ± 8.86 |
| 0.1% | 0.28 ± 0.02 | 0 | 97.93 ± 6.24 |
| 0.01% | 0.28 ± 0.02 | 0 | 97.84 ± 7.19 |
| 0.001% | 0.32 ± 0.02 | 0 | 109.74 ± 8.60 |
| 0.0001% | 0.29 ± 0.03 | 0 | 98.82 ± 8.88 |

TABLE 18
The results of nisin (mean ± SD)

| | | Qualitative grading | |
|---|---|---|---|
| Group (V/V) | OD | of cell morphology | Viability (%) |
| Blank control | 0.23 ± 0.02 | 0 | 100.00 ± 8.99 |
| Negative control | 0.20 ± 0.01 | 0 | 86.11 ± 6.21 |
| Positive control | 0.06 ± 0.01 | 4 | 23.52 ± 4.63 |
| 10% | 0.18 ± 0.01 | 2 | 75.09 ± 4.43 |
| 1% | 0.19 ± 0.01 | 1 | 78.78 ± 2.95 |
| 0.1% | 0.26 ± 0.03 | 0 | 108.96 ± 12.73 |
| 0.01% | 0.23 ± 0.01 | 0 | 96.99 ± 3.74 |
| 0.001% | 0.24 ± 0.04 | 0 | 100.55 ± 15.86 |
| 0.0001% | 0.25 ± 0.01 | 0 | 106.76 ± 5.39 |

TABLE 19
Qualitative morphological grading of cytotoxicity of the extracts

| Grade | Reactivity | Conditions of all cultures |
|---|---|---|
| 0 | None | Discrete intracytoplasmatic granules, no cell lysis, no reduction of |
| | | cell growth |
| 1 | Slight | Not more than 20% of the cells are round, loosely attached and |
| | | without intracytoplasmatic granules, or show changes in morphology; |
| | | occasional lysed cells are present; only slight growth inhibition |
| | | observable |
| 2 | Mild | Not more than 50% of the cells are round, devoid of |
| | | intracytoplasmatic granules, no extensive cell lysis; not more than |
| | | 50% growth inhibition observable |
| 3 | Moderate | Not more than 70% of the cell layer contain rounded cells or are lysed; |
| | | cell layers not completely destroyed, but more than 50% growth |
| | | inhibition observable |
| 4 | Severe | Nearly complete or complete destruction of the cell layers |

It is evidenced that the cell toxicity of AMP_NACDPLLHKP_05-05-1 is similar to the nisin standard, meaning that the sample is not cytotoxic.

Furthermore, the sample is sent to accredited third-party laboratories for assessing the chemical and biological safety. The results are shown in the Table 20.

TABLE 20
Summary of safety assessments

| | | | | | Acute |
|---|---|---|---|---|---|
| | | | Skin | Acute oral | dermal |
| | | | irritation | toxicity | toxicity |
| | | | (OECD | (OECD | (OECD |
| | RoHS* | SVHC* | 404)** | 423/425)** | 402)** |
| AMP_NACDPLLHKP_05-05-1 | Pass | Pass | Pass | Pass | Pass |

*RoHS & SVHC were performed at Bureau Veritas.
**Skin irritation Acute oral toxicity & Acute dermal toxicity were performed SGS.

The sample has passed all the safety assessments.

### Example 11. Employing AMP_NACDPLLHKP_05-05-1 as a Preservative and Validating its Effectiveness

AMP_NACDPLLHKP_05-05-1 powder can be utilized with various excipients to suit different working scenarios. For instance, freeze-dried AMP_NACDPLLHKP_05-05-1powder is dissolved in deionised water and stirred overnight to obtain a 1% nisin active spray for food products such as meats and fruits. Furthermore, the freeze-dried AMP_NACDPLLHKP_05-05-1 is incorporated in a cream base for forming a mixed and uniform cream with no observable liquefying and/or phase separation.

In order to test preservative effectiveness of AMP_NACDPLLHKP_05-05-1, the sample is submitted to an accredited third party for assessing its preservative effectiveness, following the standards outlined in BS EN ISO 11930:2019 and the United States Pharmacopoeia (USP) USP43-NF38 (2020), General Chapter 51. The results are summarized in Table 21.

TABLE 21
Summary of preservative effectiveness

| Standard | Parameter/ requirement | Conclusion |
|---|---|---|
| USP 43-NF38 (2020) | Escherichia coli | Effective |
| general chapter 51 | Pseudomonas aeruginosa | Effective |
| | Staphylococcus aureus | Effective |
| | Candida albicans | Effective |
| | Aspergillus brasiliensis | Effective |
| BS EN ISO 11930: 2019 | Escherichia coli | Effective |
| | Pseudomonas aeruginosa | Effective |
| | Staphylococcus aureus | Effective |
| | Candida albicans | Effective |
| | Aspergillus brasiliensis | Effective |

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. An acid and alkali-resistant and thermostabilized antimicrobial peptide, wherein the acid and alkali-resistant and thermostabilized antimicrobial peptide is an antimicrobial peptide bond with a structure-lock component through a non-covalent bond to maintain the antimicrobial peptide in its native conformation and encapsulated by a controlled release encapsulation material.

2. The acid and alkali-resistant and thermostabilized antimicrobial peptide of claim 1, wherein the non-covalent bond is selected from a hydrogen bond, a Van der Waals bond, a hydrophobic interaction or an electrostatic interaction.

3. The acid and alkali-resistant and thermostabilized antimicrobial peptide of claim 1, wherein the structure-lock component binds to hydrophobic residues of the antimicrobial peptide.

4. The acid and alkali-resistant and thermostabilized antimicrobial peptide of claim 1, wherein the antimicrobial peptide is selected from nisin, polylysine, cecropin, defensin, bacitracin, lacticin, a salt thereof or any combinations thereof.

5. The acid and alkali-resistant and thermostabilized antimicrobial peptide of claim 1, wherein the structure-lock component is selected from cyclodextrins, polylysine, zein, silk fibroin, silk sericin, a salt thereof or any combinations thereof.

6. The acid and alkali-resistant and thermostabilized antimicrobial peptide of claim 1, wherein the encapsulation material is a polymer or a lipid component, comprising a polyvinylpyrrolidone, a solid lipid, a natural wax and a salt thereof.

7. The acid and alkali-resistant and thermostabilized antimicrobial peptide of claim 1, wherein the acid and alkali-resistant and thermostabilized antimicrobial peptide has an antimicrobial effect against Escherichia coli, Staphylococcus aureus and Candida albicans for at least 99%.

8. The acid and alkali-resistant and thermostabilized antimicrobial peptide of claim 1, wherein the acid and alkali-resistant and thermostabilized antimicrobial peptide is stable and functioned at a pH value range of 4-10.

9. The acid and alkali-resistant and thermostabilized antimicrobial peptide of claim 1, wherein the acid and alkali-resistant and thermostabilized antimicrobial peptide is stable and functioned at a temperature range of 0-120° C.

10. A method for manufacturing an acid and alkali-resistant and thermostabilized antimicrobial peptide, comprising:
capping and/or grafting a structure-lock component on the hydrophobic residues of an antimicrobial peptide to obtain a structural-locked peptide; and
homogenizing the structural-locked peptide with an encapsulation material and a membrane penetration enhancer in a solvent to form an acid and alkali-resistant and thermostabilized antimicrobial peptide.

11. The method of claim 10, wherein the weight percentages of the antimicrobial peptide, the structure-lock component, the encapsulation material, the membrane penetration enhancer and the solvent are 0.5-38 wt. %, 0.5-38 wt. %, 0.01-5 wt. %, 0.01-47 wt. % and 0-98.98%, respectively.

12. The method of claim 11, wherein the antimicrobial peptide is 0.5-1 wt. %, the structure-lock component is 0.5-1 wt. %, the encapsulation material is 0.01-0.1 wt. %, the membrane penetration enhancer is 0.01-0.55 wt. % and the solvent is 97.35-98.98 wt. %.

13. The method of claim 11, wherein the antimicrobial peptide is 25-38 wt. %, the structure-lock component is 25-38 wt. %, the encapsulation material is 3-5 wt. % and the membrane penetration enhancer is 19-47 wt. %.

14. The method of claim 10, wherein the size of the structural-locked peptide is in a range of 100-1000 nm.

15. The method of claim 10, wherein the antimicrobial peptide is selected from nisin, polylysine, cecropin, defensin, bacitracin, lacticin, a salt thereof or any combinations thereof.

16. The method of claim 10, wherein the structure-lock component is selected from cyclodextrins, polylysine, zein, silk fibroin, silk sericin, a salt thereof or any combinations thereof.

17. The method of claim 10, wherein the encapsulation material is a polymer or a lipid component, comprising a polyvinylpyrrolidone, a solid lipid, a natural wax and a salt thereof.

18. The method of claim 10, wherein the membrane penetration enhancer is selected from citric acid, phytic acid, myristic acid, fumaric acid, mandelic acid, succinic acid, lauric acid, honokiol, poly-L-lysine or a salt thereof.

19. The method of claim 10, wherein the solvent is selected from water, isopropyl alcohol or ethyl alcohol.

20. An acid and alkali-resistant, thermostabilized and non-toxic preservative, comprising the acid and alkali-resistant and thermostabilized antimicrobial peptide of claim 1.

21. An acid and alkali-resistant, thermostabilized and non-toxic food addictive, comprising the acid and alkali-resistant and thermostabilized antimicrobial peptide of claim 1.
